(19) United States
(12) Patent Application Publication
(10) Pub. No.: US 2009/0217641 A1
(43) Pub. Date: Sep. 3, 2009

(54) Combustion System Comprising an Electrolyser

(76) Inventors: Jonathan Anthony Lloyd, Sheffield (GB); Donald James Highgate, Surrey (GB); Stephen Neal Jones, Sheffield (GB)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/278,598

(22) PCT Filed: Feb. 7, 2007
(86) PCT No.: PCT/GB07/50053

§ 371 Date: Mar. 5, 2009

(30) Foreign Application Priority Data
Feb. 7, 2006 (GB) 0602393.1
Sep. 19, 2006 (GB) 0618372.7
Sep. 19, 2006 (GB) 0618374.3

(51) Int. Cl. F02G 3/00

(52) U.S. Cl. 60/39.12

(57) ABSTRACT

A system comprises, in addition to a combustion engine having a hydrocarbon fuel inlet line and a line for fuel exhaust, an electrolyser capable of converting water to hydrogen and oxygen, and an outlet line for the hydrogen at least, wherein the outlet line leads to the engine or to the exhaust line.

### FIELD OF THE INVENTION

This invention relates to a combustion system comprising an electrolyser, and in particular to the use of hydrogen to reduce emissions from heat engines.

### BACKGROUND OF THE INVENTION

The combustion of hydrocarbon fuels using atmospheric oxygen in open cycle heat engines produces large amounts of atmospheric pollutants, principally carbon dioxide and oxides of sulphur and nitrogen. This is the situation irrespective of the type of heat engine (internal combustion of external combustion), the type of thermodynamic cycle used or the standard or maintenance of the device. This is particularly true of heat engines (e.g. diesel and petrol engines) of the type used in mobile applications, e.g. cars, lorries, trains and ships, where, in addition to the above pollutants, solid carbon particles are produced which, if of small size (e.g. less than 10 μm), are recognised as particularly damaging to health when inhaled into the lungs.

The general problem of un-burnt carbon particulate pollution is being addressed by, for example, the use of engines that achieve a more complete burn of the fuel within the combustion chamber. However, a higher temperature within the combustion chamber can facilitate production of nitrogen oxides (NOx). They contribute to acid rain and waterway pollution, and also react to form low level ozone and smog. Nitric oxide (NO) is additionally a greenhouse gas and has been highlighted as a major problem for manufacturers trying to meet emission legislation. Continued government restrictions being placed on engine emissions, particularly vehicles, mean that manufacturers have a need to increasingly reduce engine emissions.

It is now recognised that the potential damage to the general environment caused by the release of large quantities of pollutants is not acceptable if the quality of the environment is to be maintained, and significant effort is now being directed to the development of improved combustion systems. These developments are typified by the development of catalytic converters for automotive applications, and sulphur removal from electric power stations.

The replacement of coal and heavy fuel oils by light oils or gas (butane or propane) of reduced carbon footprint, has contributed to a significant reduction in the UK's carbon dioxide output. However, the reductions necessary to achieve long-term stability in the environment are considerably greater than can be achieved by this simple substitution.

The generation of hydrogen by electrolysers, from low/zero carbon footprint primary energy sources, wind power, wave power and nuclear energy, is well known. Electrolysis (specifically by means of a solid polymer electrolyte electrolyser) results in the production of high purity hydrogen (>99.99% purity) and oxygen in a precisely stoichiometric ratio.

### SUMMARY OF THE INVENTION

This invention is based in part on the utility of hydrogen produced by electrolysis from ‘zero-footprint’ energy resources to feed into heat engines to reduce the hydrocarbon fuel used and therefore the production of carbon dioxide and other pollutants. Further, it has been appreciated that it is effective to use hydrogen (and oxygen) produced by means of a lightweight modular electrolyser mounted in a vehicle and powered by the electric generator of the primary heat engine. It is to be understood that this aspect of the invention does not reduce the carbon footprint of the system except insofar as it increases the efficiency of the combustion process in the mobile heat engine in the vehicle and hence the overall amount of pollution produced by the vehicle engine. Hydrogen can be reconverted to useful energy by combustion in the vehicles engine (heat) engine. This may allow improved performance, reduced pollution in stationary and transport applications and increased range between refuelling for transportation applications.

Improvements in efficiency and reduction in pollution can itself be achieved in two ways:
(i) by the continuous introduction of hydrogen or hydrogen and oxygen into the combustion process, where the energy content of the amount of hydrogen introduced represents a small proportion of the total energy content of the fuel consumed. This has been shown to improve the combustion conditions and hence act directly to reduce the level of pollutants produced during the normal operation of the engine. A subsidiary effect of the increase in combustion efficiency is to reduce the specific fuel consumption of the engine; thus the level of pollutants is reduced in these two ways.
(ii) by substituting hydrogen (and optionally the oxygen) produced by the on-board electrolyser for a large proportion (up to 100%) of the fuel used by the engine, for restricted periods of operation. The combustion of hydrogen in oxygen produces nothing but water and hence the use of hydrogen and oxygen from the electrolyser as the primary fuel for the engine greatly reduces the output of pollutants of all kinds. This process is of particular significance at times when the engine would otherwise produce unusually large amounts of pollution, e.g. when the engine is cold, or for very short periods during changes of load (during acceleration).

The invention is particularly applicable to mobile and transport systems, where the heat engine and electrolyser are both on board. Such systems include vehicles, aeroplanes and ships.

Another aspect of this invention is an on-board electrolyser which can be used in conjunction with a gas storage device. This allows the addition of hydrogen and or oxygen into the combustion process in a non-uniform manner. An alternative to the storage facility is to control the electrical input in a varying manner to produce the gas (or gases, as will be understood) at varying output depending on demand. The gas may be used in the combustion chamber to increase efficiency and reduce carbon-based fuel use, or into the exhaust to reduce the pollution level in the exhaust on exit.

A further aspect of the invention is based on the realisation that hydrogen and/or oxygen produced by electrolysis can be utilised in the exhaust line of a heat engine, to reduce harmful emissions such as NOx and CO whilst simultaneously eliminating the need for expensive catalytic treatments and increase combustion efficiency. As for other aspects of this invention, this may be continuous or varying on demand.

A photoelectrolysis cell is able to product hydrogen directly from sunlight and water, and can also be used in this invention.

### BRIEF DESCRIPTION OF THE DRAWINGS

FIGS. 1 and 2 are each graphs of fuel efficiency with respect to flow rate.

FIG. 3 shows schematic representations of illustrative systems incorporating a heat engine and a electrolyser.

### DESCRIPTION OF THE INVENTION

One embodiment of the present invention utilises the hydrogen (and/or oxygen) in a gas turbine; the addition of hydrogen to the gas fuel reduces the requirement for hydrocarbon fuels for the same power output, resulting in a lower pollution burden and reduced hydrocarbon fuel consumption.

Another embodiment of the present invention utilises the hydrogen (and/or oxygen) in a heat engine at start-up, to allow the engine to heat up prior to switching to the hydrocarbon fuel. In automotive applications, for example, the catalysts used to reduce pollution require time to heat up before reaching the desired activity. Removing the requirement to burn hydrocarbons in this early cold stage may dramatically reduce pollution and carbon emissions.

Further embodiments of the invention are applicable to stationary heat engines, where the hydrogen may additionally be derived from low/zero carbon footprint electricity, for example in a coal power station; in such cases, hydrogen can be utilised as a fuel to heat the boiler, to make steam that drives the steam turbine. Alternatively or additionally the hydrogen and oxygen can be recombined into the steam stream, after hydrocarbon combustion and prior to the steam turbine. Alternatively or additionally, the hydrogen and oxygen can be recombined to re-heat the steam stream to optimise it for the next stage in the turbine.

In some applications, a reduced hydrocarbon fuel requirement may offer additional advantages. For aircraft, the increase in combustion efficiency derived from the use of hydrogen and oxygen results in a reduced weight burden for hydrocarbon fuel. This offers additional benefits of further reducing the fuel requirement, thus impacting further on the reduction of pollutants and hydrocarbon fuel conservation.

The operating conditions of the electrolyser may be varied smoothly and continuously to provide the required hydrogen on demand as necessary to match the input energy generation rate to the output demand. This may be done in response to engine sensors and characteristics.

The oxygen produced by electrolysis can be used if desired. For example, it can be utilised in the oxidant feed, in most cases with atmospheric air, to further assist the combustion process and reduce pollutants.

It will be appreciated that a system of the invention may be provided in a stationary application, or it may be an on-board, mobile system. For stationary applications, such as power stations, the electrolyser should be principally low cost; for transportable applications such as aircraft and ships, the electrolyser must be low weight or neutral buoyancy, vibration-resistant, able to operate in varying conditions (to include pressure and temperature) and be able to vary the output to meet the required hydrogen demands of the system.

An embodiment of the invention is a domestic or larger re-fuelling system, where the electrolyser is not on board but attached to a storage facility on board. For example, an electrolyser in garage provides hydrogen for home use, and (at night) a car is plugged into and stores hydrogen on board (for use the next day). For this purpose, some storage means should be provided.

In an aspect of the invention utilising an on-board electrolyser, it can be powered by an electric generator of the primary heat engine, to produce hydrogen and oxygen during operation. The input to the electrolyser may be steady-state, or variable.

The electrolyser may be anionic and/or cationic and preferably hydrophilic (to allow water use on one-side only of the cell); it may additionally have non-ionic hydrophilic regions, to allow better hydration control in use. A typical electrolyser comprises a hydrophilic membrane separated by electrodes, in a membrane electrode assembly (MEA) of the type described in WO03/023890, the content of which is incorporated herein by reference. A solid polymer electrolyte (SPE) may be used, anionic (AE) or cationic (CE). A known catalyst may be incorporated in the MEA.

The invention can provide, by way of example, a small on-board AE-SPE with store and flow modification devices, and a non-Pt SPE using hydrophilic membranes. This particular example can be achieved by the more generally applicable utilisation of a high pressure (storable H₂) hydrophilic SPE. Benefits include self-pressuring, the use of non-Pt catalysts with AE, the use of a membrane which is hydrophilic so water is on only one side (AE's require water on H₂ side; CE's require water on O₂ side), and the ability to cope with varying loads over time. They are also easy to switch on and off.

If the electrolyser output is controlled by the electrical input, gases may be produced on demand and used immediately. Alternatively, some or all of the hydrogen and or oxygen may be stored in one or more on-board storage vessels, and used when maximum benefit can be obtained, to increase power output e.g. high acceleration, or to mitigate high pollution, low efficiency periods, e.g. at start-up.

If the electrical input is steady-state, then the gases are generated uniformly at all times. If generation is at a rate higher that the “base-line usage” (the amount of gas introduced to the engine and/or exhaust under steady-state cruising driving conditions), the excess may also be stored on-board and used when maximum benefit can be obtained. Additionally, when the engine is at maximum efficiency, “base-line” gas can be diverted from the engine and stored for later use. Utilising such a storage facility allows further improvements on combustion efficiency and exhaust treatment.

In the aspect of the invention which is utilised to affect the exhaust, these are two particular, illustrative embodiments. Both use an electrolyser as the electrochemical cell.

A first example is the use of electrolytic product gases in a stationary application, such as a gas turbine; in such stationary applications, the electrolyser should be principally low cost and the input electricity preferably has a zero/low carbon footprint. The electrolytic hydrogen (and/or oxygen) is used in the exhaust line of the turbine, and reduces the amount of harmful emissions released into the atmosphere.

A second example is the use of electrolytic product gases in a mobile application, such as a car. The electrolytic hydrogen (and/or oxygen) is introduced into the exhaust line of a heat engine; the addition of hydrogen to the exhaust stream reduces the amount of harmful emissions released into the atmosphere. In some applications, the resulting reduction for expensive and heavy catalytic converters may offer both an economic advantage and a weight reduction. For future motor sport vehicles, it is thought that some emission regulation is inevitable; and there is a weight advantage consequent on using a lightweight electrolyser rather than a heavy catalyst. Weight reduction offers additional benefits, of further reducing the fuel requirement (increasing efficiency), thus impacting further on the reduction of pollutants and hydrocarbon fuel conservation.

For both types of applications, the operating conditions of the electrolyser may be varied smoothly and continuously to provide the required hydrogen and/or oxygen on demand as necessary to match the input energy generation rate to the output demand.

Some examples of reactions with emissions are:

CxHy+(x+y/4)O₂→xCO₂+(y/2)H₂O (general equation for hydrocarbon combustion)

2NO+2H₂→N₂+2H₂O

NO₂+2H₂½N₂+2H₂O

N₂O+H₂→N₂+H₂O

C+O₂→CO₂

CO+2H₂→CH₃OH

CO+½O₂43 CO₂

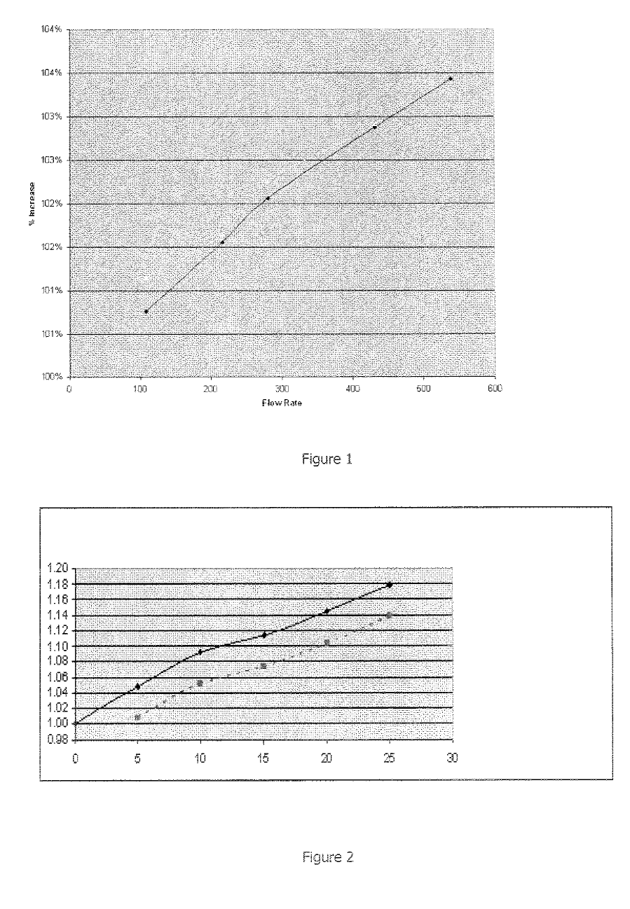

In all types of system, the method of combining emissions with the reactants produced from the electrochemical cell can be varied. Some embodiments are shown in FIG. 1. In different applications, different methods will be preferred, either singularly or in combination. Optionally, the water produced may be recycled back into the electrolyser.

The reactants from a conventional electrolyser, hydrogen and oxygen, may be transported via a hose into the exhaust stream. The exhaust line from a heat engine has an inherent temperature gradient (hotter nearer the combustion chamber, cooler nearer the exit); this can be used to advantage, by introducing the electrolytic products to the exhaust gas at various stages based on the temperature required to perform the required reaction. Additionally, the heat energy of the exhaust may be used to increase the temperature of the electrolyser system; heating the electrolyser may increase the efficiency of the electrochemical cell. The electrolyser may also be linked to the temperature control system in a combustion engine system, for example for mobile applications such as a vehicle, allowing management of the temperature and pressure in the system.

Depending on where the gases are injected, and how many injection areas are present, different reactions may be promoted. Different catalysts may be present at different sections along the exhaust, if required.

It will be appreciated that elements of the invention require control of energy or fuel supply input, and/or gas or exhaust conditions/temperature/output. For example, it may be appropriate to monitor gas generation during over-run or braking. Under such conditions, power can be “dumped” into the electrolyser. Whether or not in a mobile system, the electrolyser can be optimized for general running (lower power).

Each condition may be monitored and/or determined by the use of a suitable sensor in situ. Control may be by a computer system. In a particular embodiment, hydrogen is produced using an additional or oversized generator specifically engaged when the engine is “on overrun” or when a vehicle is being braked. Used in conjunction with a hydrogen store and control electronics to ensure that the hydrogen is used intermittently, it is possible to optimize either the combustion process (for fuel savings during stop start operating cycles) or to reduce the emission either in the combustion chamber or subsequently in the exhaust system.

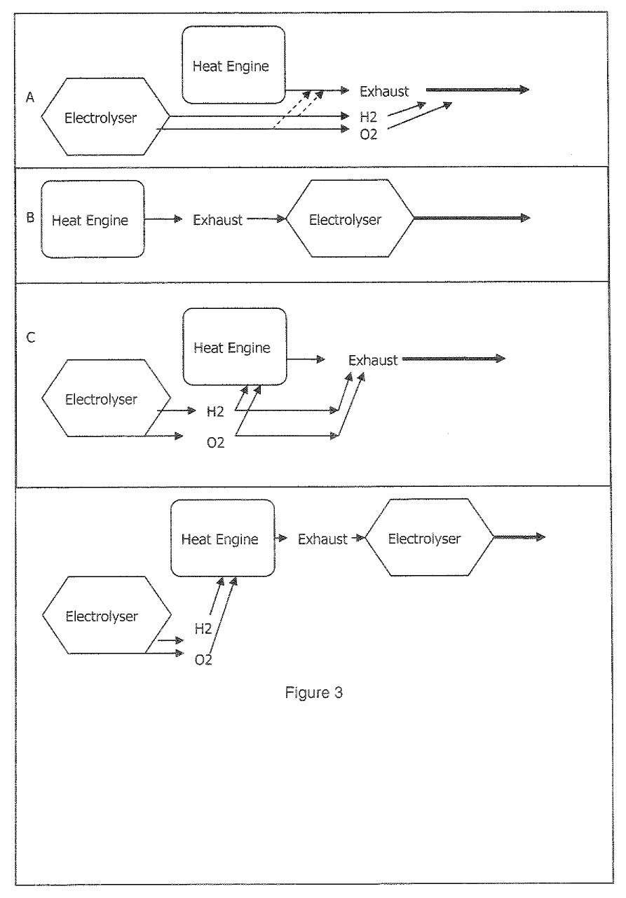

Embodiments of the invention are illustrated in FIG. 3 which shows 4 schemes, as follows:

Scheme A: The electrolyser feeds hydrogen and oxygen into the exhaust line of the heat engine, at a single point or at multiple points.

Scheme B: The exhaust from the heat engine is fed directly into an electolyser, with the cleaner exhaust exiting the cell. In the case of a hydrophilic cationic PEM electrolyser, the exhaust can be fed directly into the chamber where hydrogen is produced, and be reduced, whilst in the case of a hydrophilic anionic PEM electrolyser, the exhaust may be fed into the chamber where the oxygen is produced and may be oxidized. The use of hydrophilic systems allows this, as water is only required on one side of the electrochemical device.

Scheme C: The electrolyser feeds hydrogen and oxygen into both the heat engine and the exhaust, thereby increasing efficiency of combustion and cleaning the exhaust.

Scheme D: An electrolyser feeds into the heat engine, improving the combustion efficiency, and the exhaust from the heat engine fees into an electrolyser which exists the cleaner exhaust.

The following Examples illustrate the invention.

### EXAMPLE 1

For this experiment, the equipment used was a 1.6 litre, naturally aspirated, Ford diesel engine on a water brake engine dynamometer. Due to the unknown effects hydrogen has on combustion, a static test was conducted and the test sites chosen for engine speed and load were well within the normal operating area of the engine. The test site was chosen to be 1100 rpm engine speed and 50 Nm loading. Baseline tests were initially run to establish a fuel economy characteristic for the engine at this site; the method was to observe the time the engine took to use 70 cm³ of diesel fuel. This was repeated three times and averaged for each test sight (1100 rmp @ 50 Nm).

The introduction of hydrogen, at low flow rate, was tested at two points on the engine, in the riser and the manifold. Each location was tested separately with a range of flow rates. The same procedure used to acquire the baseline data was repeated for the introduction of hydrogen at each location.

Integrating an electrolyser onto the vehicle is an extra drain on the vehicle system. To ensure the test preformed was an accurate representation, compensation was added to the loading on the engine in line with the electrolyser's draw required to generate each flow rate.

Results, in terms of % fuel efficiency with respect to flow rate (ml/min) of hydrogen, for introduction into the manifold, are shown in FIG. 1. Similar results were obtained for introduction into the riser.

### EXAMPLE 2

Hydrogen, at a high flow rate, was introduced as an additive to normal diesel fuel flow to a combustion engine, as in Example 1. Results, in terms of % fuel efficiency with respect to flow rate (ml/min) of hydrogen, for introduction into the manifold, are shown in FIG. 2. The upper curve represents hydrogen from a zero carbon footprint, i.e. solar cell/wind turbine, where the hydrogen is produced separately from the heat engine. The lower curve represents hydrogen produced on-board, where the engine has been loaded with the power required to produce the hydrogen via the engine's alternator.

These results showed increased in efficiencies to 18% (14% adjusted for compensation, assuming the power input from the electrolyser was provided by the engine) with a high input of hydrogen (25 L/min) (FIG. 2), and 4% (adjusted for compensation) with a low flow rate (500 L/min) FIG. 1). In both cases, as indicated above, hydrogen was used as an additive to normal diesel flow in an internal combustion engine.

1. A system comprising, in addition to a combustion engine having a hydrocarbon fuel inlet line and a line for fuel exhaust, an electrolyser capable of converting water to hydrogen and oxygen, and an outlet line for the hydrogen at least, wherein the outlet line leads to the engine or to the exhaust line.

2. The system according to claim 1, wherein the outlet line leads to the engine and the system additionally comprises means for controlling the relative amounts of fuel and hydrogen that pass to the engine.

3. The system according to claim 1, wherein the outlet line leads to the engine and the vehicle additionally comprises means for supplying the engine with hydrogen under predetermined conditions only.

4. The system according to claim 3, wherein the predetermined conditions are starting and/or acceleration.

5. The system according to claim 1, wherein the outlet line comprises a gas storage device, and the system comprises means for controlling the amount of hydrogen that passes to the engine or the exhaust line.

6. The system according to claim 1, wherein the outlet line leads to the exhaust line.

7. A system comprising, in addition to a combustion engine having a hydrocarbon fuel inlet line and a line for fuel exhaust, an electrolyser capable of converting water to hydrogen and oxygen, in said line.

8. The system according to claim 1, which additionally comprises means for monitoring a condition of the system, and means for controlling the system in response thereto.

9. The system according to claim 1, wherein the electrolyser comprises electrodes separated by a hydrophilic membrane.

10. The system according to claim 1, which is a mobile system.

11. The system according to claim 10, wherein the electrolyser is provided separately, and the on-board system comprises means for storing hydrogen at least.

12. The system according to claim 10, which is a motor vehicle, aeroplane or ship.

13. The system according to claim 7, which additionally comprises means for monitoring a condition of the system, and means for controlling the system in response thereto.

14. The system according to claim 7, wherein the electrolyser comprises electrodes separated by a hydrophilic membrane.

15. The system according to claim 7, which is a mobile system.

16. The system according to claim 15, wherein the electrolyser is provided separately, and the on-board system comprises means for storing hydrogen at least.

17. The system according to claim 15, which is a motor vehicle, aeroplane or ship.
